(19) United States
(12) Patent Application Publication
(10) Pub. No.: US 2013/0200747 A1
(43) Pub. Date: Aug. 8, 2013

(54) MOTOR AND WASHING MACHINE HAVING THE SAME

(71) Applicant: Samsung Electronics Co., Ltd., Suwon-si (KR)

(72) Inventors: Myung Bae BANG, Pyeongtaek-si (KR); Keun Young YOON, Osan-si (KR); Sung Gu LEE, Anyang-si (KR); Byung Ryel IN, Yongin-si (KR); Su Kwon JEONG, Suwon-si (KR); Woong HWANG, Suwon-si (KR); Young Kwan KIM, Anyang-si (KR)

(73) Assignee: Samsung Electronics Co., Ltd., Suwon-si (KR)

(21) Appl. No.: 13/754,148

(22) Filed: Jan. 30, 2013

(30) Foreign Application Priority Data
Feb. 7, 2012 (KR) 10-2012-0012212

(51) Int. Cl. H02K 1/12

(52) U.S. Cl. CPC H02K 1/12
USPC 310/254.1

(57) ABSTRACT

A motor having an improved structure to be driven while maintaining a constant level of performance, and a washing machine having the same, the washing machine including a body, a tub disposed inside the body, a drum rotatably disposed inside the tub, and a motor coupled to a rear surface of the tub to drive the drum, wherein the motor includes a stator, which includes at least one fixing pin inserted into the rear surface of the tub; and at least one fixing hole concentrically disposed with the at least one fixing pin, and a rotor rotatably disposed at an inner side or at an outer side of the stator.

### CROSS-REFERENCE TO RELATED APPLICATIONS

This application claims the priority benefit of Korean Patent Application No. 10-2012-0012212, filed on Feb. 7, 2012, in the Korean Intellectual Property Office, the disclosure of which is incorporated herein by reference.

### BACKGROUND

1. Field

Embodiments relate to a motor configured to generate rotational force, and a washing machine having the same.

2. Description of the Related Art

A washing machine is an apparatus configured to wash clothes by use of power, and in general, includes a tub to store washing water, a drum rotatably installed at an inside the tub, and a motor configured to rotatably drive the drum.

The motor is an apparatus configured to obtain rotational force from electric energy, and includes a stator and a rotor. The rotor is configured to electromagnetically interact with the stator, and is rotated by the force acting in between a magnetic field and the current that flows at coils.

In general, the stator is fixed to a rear wall of the tub by use of a plurality of fixing pins and bolts. The fixing pins are configured to determine the position of the stator, and the bolts are configured to fix the stator, the position of which is determined by the fixing pin, to a rear wall of the tub.

The stator is provided with fixing pins, separately formed from penetration holes into which the bolts are inserted. In the case as such, in processing the fixing pins and penetration holes, due to a processing error, the stator may not be able to be fixed at a right position, and thus a concentricity defect may be occurred between the stator and the rotor, thereby resulting in a decreased performance and a difference in the performance of the motor. In a case when the concentricity defect is severe, interference between the rotor and the stator may be occurred.

### SUMMARY

In an aspect of one or more embodiments, there is provided a motor having an improved structure to be driven while maintaining a constant level of performance, and a washing machine having the same.

In an aspect of one or more embodiments, there is provided a motor having an improved structure to prevent water from penetrating into an inner side of the motor, and a washing machine having the same.

In an aspect of one or more embodiments, there is provided a motor having an improved structure to enhance productivity and assembly performance, and a washing machine having the same.

In accordance with an aspect of one or more embodiments, there is provided a washing machine which includes a body, a tub, a drum, and a motor. The tub may be disposed inside the body. The drum may be rotatably disposed inside the tub. The motor may be coupled to a rear surface of the tub to drive the drum. The motor may include a stator and a rotor. The stator may include at least one fixing pin inserted into the rear surface of the tub, and at least one fixing hole concentrically disposed with the at least one fixing pin. The rotor may be rotatably disposed at an inner side or at an outer side of the stator.

The stator may include a stator body and at least one fixing rib. The stator body may have a circular-shape. The at least one fixing rib may be disposed in a circumferential direction of the stator body, and may protrude from one side surface of the stator body toward the rear surface of the tub. The at least one fixing pin may protrude from the at least one fixing rib toward the rear surface of the tub.

The at least one fixing rib may include a plurality of fixing ribs separated from each other and disposed in the circumferential direction of the stator body, and may protrude from one side surface of the stator body toward the rear surface of the tub, and the at least one fixing pin may include a plurality of fixing pins and each fixing pin may protrude from each fixing rib toward the rear surface of the tub.

The at least one fixing hole may be penetratively formed through a center of the at least one fixing pin, through a portion of the stator body at which the center of the at least one fixing pin is positioned, and through the at least one fixing rib.

The tub may include at least one first accommodation hole and at least one second accommodation hole. The at least one first accommodation hole may allow the at least one fixing pin to be insertedly accommodated therein. The at least one second accommodation hole may be concentrically disposed with the at least one first accommodation hole, and configured to communicate with the at least one fixing hole in a state that the at least one fixing pin is insertedly accommodated in the at least one first accommodation hole.

The washing machine may further include at least one fixing member configured to fix the stator to the rear surface of the tub. The at least one fixing member may be fixedly accommodated in the at least one second accommodation hole after passing through the at least one fixing hole.

The tub may include a support rib protruded from the rear surface of the tub toward a rear side, and configured to support the stator by making contact with the at least one fixing rib when the stator is in a fixed state. The at least one first accommodation hole and the at least one second accommodation hole may be formed at the support rib.

The stator may include a stator body having a circular-shape, a plurality of stator teeth, a coil and at least one water penetration prevention member. The plurality of stator teeth may be arranged in a circumferential direction of the stator body. The coil may be wound around the plurality of stator teeth. The at least one water penetration prevention member may be protruded from the stator body and configured to prevent water from penetrating into the coil.

The at least one water penetration prevention member may include a first water penetration prevention rib and a second water penetration prevention rib. The first water penetration prevention rib may be protruded from one surface of the stator body that faces the rear surface of the tub toward the rear surface of the tub when the stator is fixed to the rear surface of the tub. The second water penetration prevention rib may be protruded from the other surface of the stator body opposite to the one surface of the stator body in an opposite direction to the first water penetration prevention rib when the stator is fixed to the rear surface of the tub.

The at least one water penetration prevention member may be disposed in the circumferential direction of the stator body.

The stator includes a stator body having a circular-shape, a plurality of stator teeth, a coil and a connector housing. The plurality of stator teeth may be arranged in a circumferential direction of the stator body. The coil may be wound around the plurality of stator teeth. The connector housing may be integrally formed with the stator body and into which a connector configured to supply power to the coil is inserted.

In accordance with an aspect of one or more embodiments, there is provided a washing machine includes a body, a tub, a drum, and a motor. The tub may be disposed inside the body. The drum may be rotatably disposed inside the tub. The motor may be coupled to a rear surface of the tub to drive the drum. The motor may include a stator and a rotor. The stator may include a stator body having a circular-shape, a plurality of stator teeth, a coil and at least one water penetration prevention member. The plurality of stator teeth may be arranged in a circumferential direction of the stator body. The coil may be wound around the plurality of stator teeth. The at least one water penetration prevention member may be protruded from the stator body and configured to prevent water from penetrating into the coil. The rotor may be rotatably disposed at an inner side of the stator.

The at least one water penetration prevention member may include a first water penetration prevention rib and a second water penetration prevention rib. The first water penetration prevention rib may be protruded from one surface of the stator body that faces the rear surface of the tub toward the rear surface of the tub when the stator is fixed to the rear surface of the tub. The second water penetration prevention rib may be protruded from the other surface of the stator body opposite to the one surface of the stator body in an opposite direction of the first water penetration prevention rib when the stator is fixed to the rear surface of the tub.

The at least one water penetration prevention member may be disposed in the circumferential direction of the stator body.

The washing machine may further include at least one fixing rib protruded from one side surface of the stator body toward the rear surface of the tub. The fixing rib may be disposed at an outer side of the first water penetration prevention rib in a radial direction of the stator body.

In accordance with an aspect one or more embodiments, there is provided a washing machine includes a body, a tub, a drum, and a motor. The tub may be disposed inside the body. The drum may be rotatably disposed inside the tub. The motor may be configured to drive the drum. The motor may include a stator and a rotor. The stator may include a stator core, an insulator, a coil and a connector housing. The insulator may cover the stator core. The coil may be wound around the insulator. The connector housing may be integrally formed with the insulator and into which a connector configured to supply power to the coil is inserted. The rotor may be rotatably disposed at an inner side or at an outer side of the stator.

The insulator may include an upper insulator and a lower insulator that are configured to cover the stator core from an upper side and a lower side thereof, respectively. The connector housing may be integrally formed with one of the upper insulator and the lower insulator.

The washing machine may further include connection terminals formed of metal configured to electrically connect the coil to the connector. The connection terminals may be inserted into the insulator.

As described above, a fixing pin configured to determine the position of a stator is concentrically disposed with a fixing hole, into which a fixing member configured to fix the stator, so that the stator is fixed to a determined position at all times, and thereby the concentricity defect between the stator and a rotor is prevented.

Since the water that falls from an upper portion of a tub is guided to an outer side of coils along a water penetration prevention rib formed at a stator, a short circuit caused by the penetration of water is prevented.

Since a connector housing, into which a connector configured to supply power to coils is inserted, is integrally formed with a stator, the cost of separately molding the connector housing is saved, and the process of assembling the separately-molded connector housing to the stator is omitted, and thereby the productivity and assembly performance are enhanced.

In addition, the durability of a motor is enhanced.

### BRIEF DESCRIPTION OF THE DRAWINGS

These and/or other aspects of the disclosure will become apparent and more readily appreciated from the following description o embodiments, taken in conjunction with the accompanying drawings of which:

FIG. 1 is a drawing illustrating a washing machine in accordance with an embodiment;

FIG. 2 is a drawing illustrating a stator and a rotor of a motor in accordance with one embodiment of the present disclosure, the stator illustrated as being separated from the rotor;

FIG. 3 is an enlarged view of ‘B’ portion of FIG. 2;

FIG. 4 is a drawing illustrating an appearance of the stator of FIG. 2 seen from a different angle;

FIG. 5 is an enlarged view of ‘C’ portion of FIG. 4;

FIG. 6 is a cross-sectional view illustrating a coupling relationship between a tub and the stator;

FIG. 7 is an enlarged view of ‘A’ portion of FIG. 1; and

FIG. 8 is an exploded perspective view illustrating an exploded structure of the stator.

### DETAILED DESCRIPTION

Reference will now be made in detail to embodiments of the present disclosure, examples of which are illustrated in the accompanying drawings, wherein like reference numerals refer to like elements throughout.

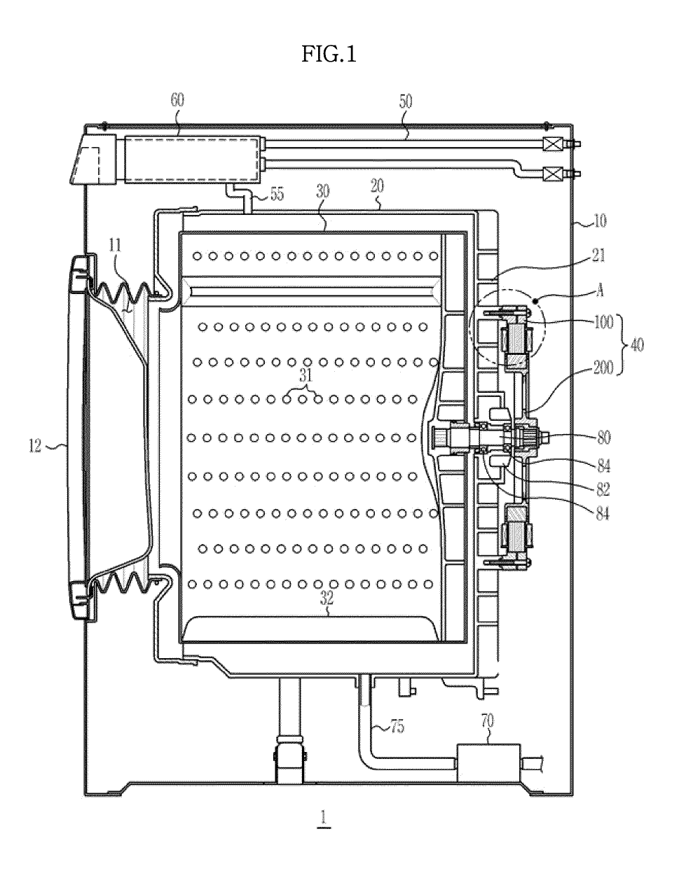

FIG. 1 is a drawing illustrating a washing machine in accordance with an embodiment.

As illustrated on FIG. 1, a washing machine 1 includes a cabinet 10, a tub 20 disposed at an inside the cabinet 10, a drum 30 rotatably disposed at an inside the tub 20, and a motor 40 rotatably driving the drum 30.

At a front surface portion of the cabinet 10, an inlet 11 is formed so that a laundry may be inserted into an inside the drum 30. The inlet 11 is open/closed by a door 12 installed at the front surface portion of the cabinet 10.

At an upper portion of the tub 20, a water supply pipe 50 is installed to supply washing water to the tub 20. One side of the water supply pipe 50 is connected to an outside water supply source (not shown), and the other side of the water supply pipe 50 is connected to a detergent supply apparatus 60. The detergent supply apparatus 60 is connected to the tub 20 through a connection pipe 55. The water being supplied through the water supply pipe 50 passes through the detergent supply apparatus 60, and then is supplied to an inside the tub 20 along with detergent.

At a lower portion of the tub 20, a drain pump 70 and a drain pipe 75 configured to discharge the water at an inside the tub 20 to an outside the cabinet 10.

At the circumference of the drum 30, a plurality of penetration holes 31 is formed to circulate the washing water, and at the inner circumferential surface of the drum 30, a plurality of lifters 32 is installed so that the ascension and the descension of the laundry may take place when the drum 30 is rotated.

The drum 30 is connected to the motor 40 through a driving shaft 80. The driving shaft 80 is configured to deliver the rotational force of the motor 40 to the drum 30. One end portion of the driving shaft 80 is connected to the drum 30, and the other end portion of the driving shaft 80 is extended to an outer side of a rear wall 21 of the tub 20.

At the rear wall 21 of the tub 20, a bearing housing 82 is installed to rotatably support the driving shaft 80. The bearing housing 82 may be formed of aluminum alloy, and may be inserted into the rear wall 21 of the tub 20 when the tub 20 is injection-molded. In between the bearing housing 82 and the driving shaft 80, bearings 84 are installed so that the driving shaft 80 may be smoothly rotated.

Hereinafter, a structure and a principle of the motor 40 being mounted at the rear wall 21 of the tub 20 will be described in detail.

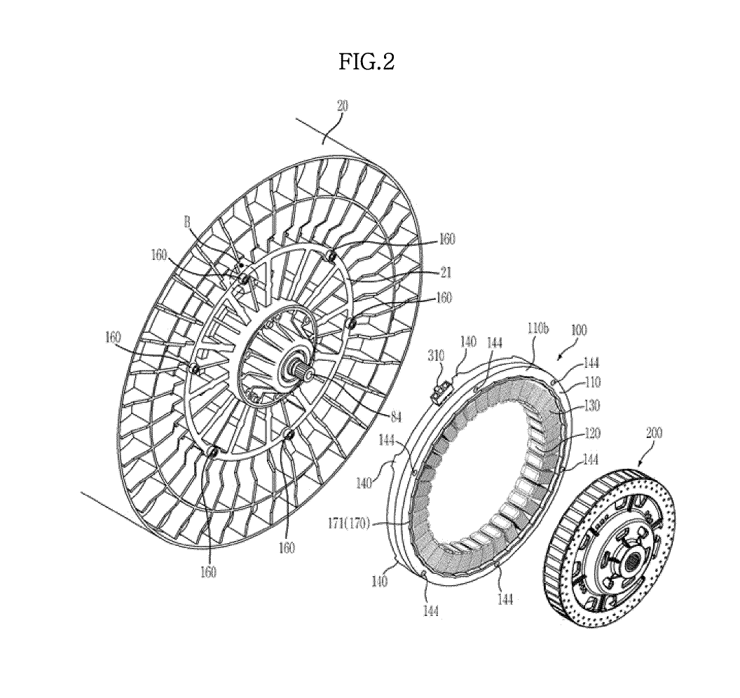

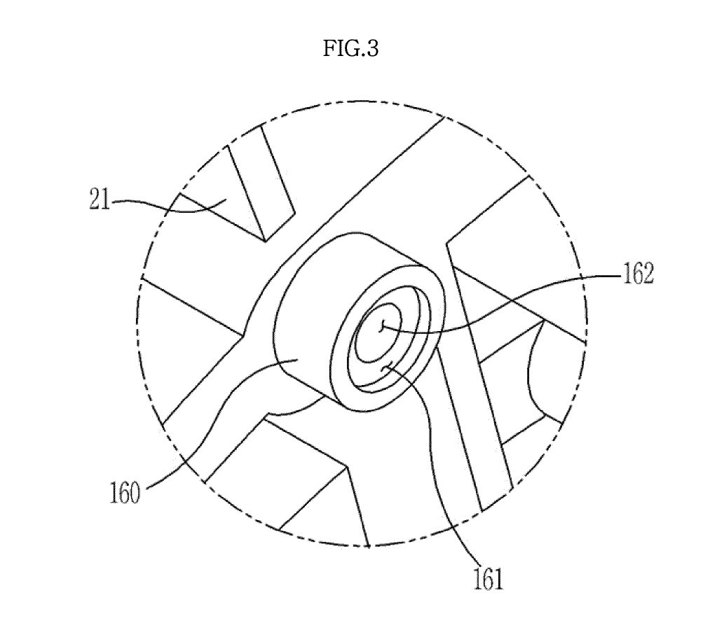

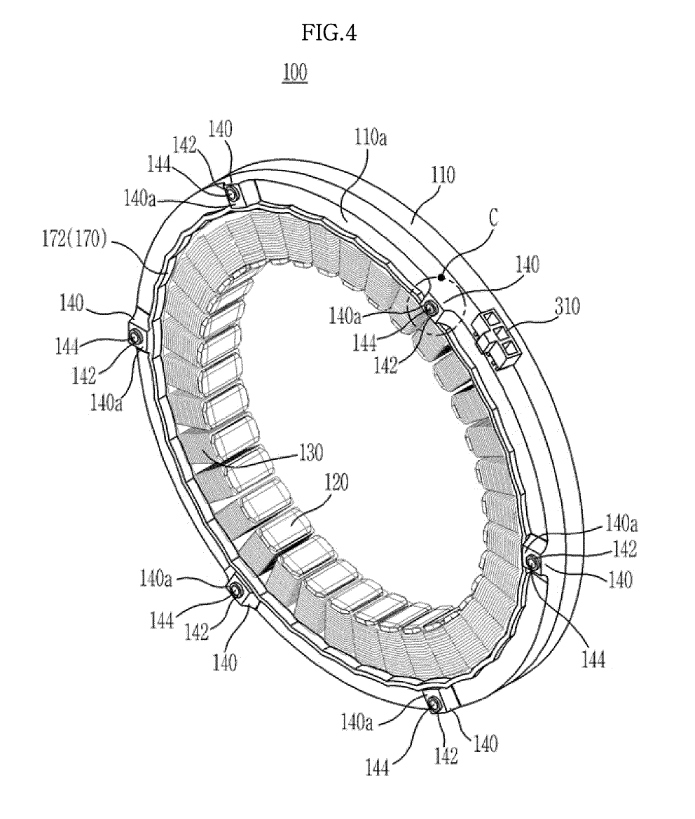

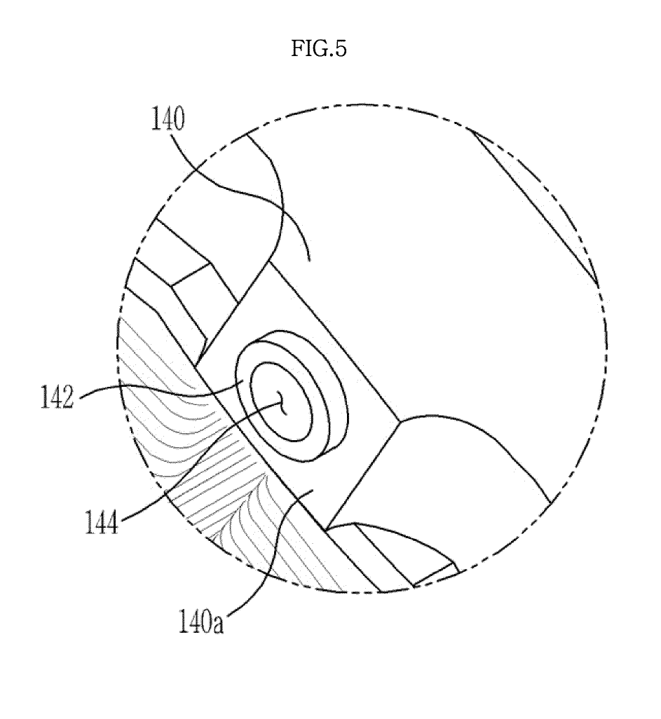

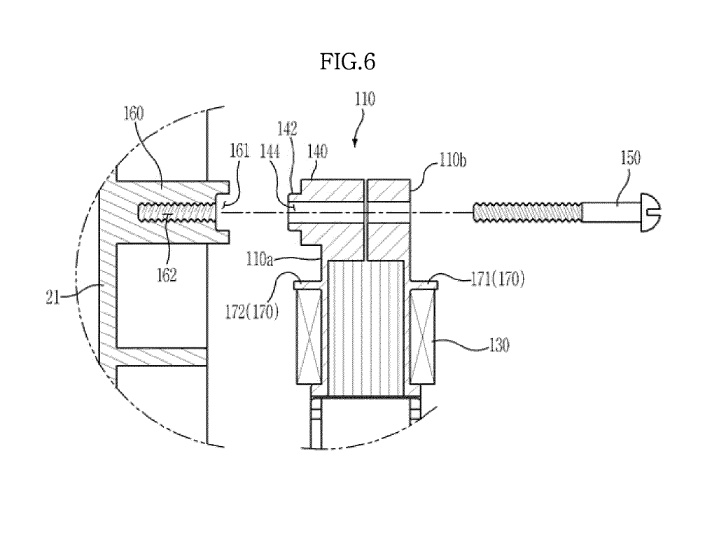

FIG. 2 is a drawing illustrating a stator and a rotor of a motor in accordance with one embodiment of the present disclosure, the stator illustrated as being separated from the rotor. FIG. 3 is an enlarged view of ‘B’ portion of FIG. 2. FIG. 4 is a drawing illustrating an appearance of the stator of FIG. 2 seen from a different angle. FIG. 5 is an enlarged view of ‘C’ portion of FIG. 4. FIG. 6 is a cross-sectional view illustrating a coupling relationship between a tub and the stator. The motor in accordance with one embodiment of the present disclosure includes an inner-rotor type in which the rotor is disposed at an inner side of the stator, and an outer-rotor type in which the rotor is disposed at an outer side of the stator, and hereinafter, for the sake of convenience, the description will be provided based on the inner-rotor type motor.

As illustrated on FIGS. 1 to 6, the motor 40 is coupled to an outer side of the tub 20, and rotates the drum 30 in both directions by providing driving force to the drum 30. The motor 40 includes a stator 100 mounted at the rear wall 21 of the tub 20, and a rotor 200 disposed around the stator 100 and configured to be rotated by electromagnetically interacting with the stator 100.

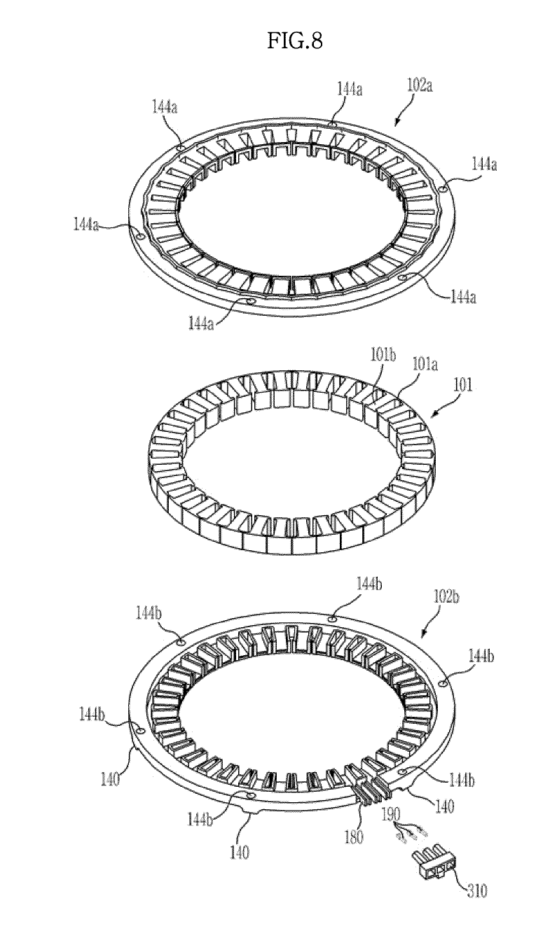

The stator 100 includes a stator body 110 in a circular shape, which is formed by coupling a stator core 101 of metallic material with insulators 102a and 102b that cover the stator core 101 from an upper side and a lower side of the stator core 101 (refer to FIG. 8), a plurality of stator teeth 120 arranged in a circumferential direction of the stator body 110, a coil 130 wound around the plurality of stator teeth 110, a plurality of fixing ribs 140, a plurality of fixing pins 142, and a plurality of fixing holes 144 configured to fix the stator 100 to the rear wall 21 of the tub 20.

The stator body 110 is configured to support the plurality of stator teeth 120. The plurality of stator teeth 120 is protruded in a radial structure in a direction facing a center of the stator body 110 from an inner circumferential surface of the stator body 110, and is arranged in a circumferential direction of the stator body 110 while being spaced apart from each other.

The plurality of fixing ribs 140 are protrudedly formed in a predetermined length toward the rear wall 21 of the tub 20 from one side surface 110a of the stator body 110 facing the rear wall 21 of the tub 20, and are disposed while being spaced apart from each other by a predetermined distance in a circumferential direction of the stator body 110.

The plurality of fixing pins 142 is protruded in a predetermined length toward the rear wall 21 of the tub 20 from one surface 140a of the plurality of fixing ribs 140 facing the rear wall 21 of the tub 20. The plurality of fixing pins 142, while being inserted into the rear wall 21 of the tub 20, is configured to determine the position of the stator 100 prior to fixing the stator 100 to the rear wall 21 of the tub 20.

Each of the fixing hole 144 is concentrically disposed with each of the fixing pins 142, and is formed by penetrating through a center of the fixing pin 142, through a portion of the stator body 110 at which the center of the fixing pin 142 is positioned, and through the fixing rib 140. A fixing member 150 such as bolts is fixed to the rear wall 21 of the tub 20 through the fixing hole 144.

The plurality of fixing ribs 140, the plurality of fixing pins 142, and the plurality of fixing holes 144 may be integrally formed with each other at the insulators 102a and 102b in the process of injection-molding the insulators 102a and 102b.

A support rib 160 configured to support the stator 100 by making contact with the fixing rib 140 while in a state that the stator 100 is mounted at the rear wall 21 of the tub 20, a first accommodation holes 161 through which the fixing pin 142 is insertedly accommodated, and a second accommodation hole 162 concentrically disposed with the first accommodation hole 161 are provided at the rear wall 21 of the tub 20 at which the stator 100 is mounted.

The support rib 160 is protruded toward a rear direction from the rear wall 21 of the tub 20, and is formed at the rear wall 21 of the tub 20 at a position corresponding to the fixing rib 140 so as to make contact with the fixing ribs 140 while in a state that the stator 100 is mounted.

The first accommodation hole 161 is configured to accommodate the fixing pin 142, so that the position of the stator 100 may be determined before the stator 100 is fixed to the rear wall 21 of the tub 20, while the second accommodation hole 162 is configured to accommodate the fixing member 150 such as a bolt, so that the stator 100 may be fixed to the rear wall 21 of the tub 20. The second accommodation hole 162 may be provided with a smaller diameter when compared to the first accommodation hole 161.

The first accommodation hole 161 and the second accommodation hole 162 may be integrally formed with each other at the tub 20 in the process of injection-molding the tub 21.

As the above, since the fixing pin 142 and the fixing hole 144 are concentrically positioned with each other, when an injection mold of the insulators 102a and 102b forming the stator body 110 is manufactured, a tool configured to process the fixing pin 142 and the fixing hole 144 may be able to simultaneously process the fixing pin 142 and the fixing hole 144 at one position, and thus the processing position error of the fixing pin 142 and the fixing hole 144 may be decreased. In the same manner, since the first accommodation hole 161 and the second accommodation hole 162 corresponding to the fixing pin 142 and the fixing hole 144, respectively, are concentrically positioned with each other, when an injection mold of the tub 20 is being manufactured, a tool configured to process the first accommodation hole 161 and the second accommodation hole 162 may be able to simultaneously process the first accommodation hole 161 and the second accommodation hole 162 at one position, and thus the processing position error of the first accommodation hole 161 and the second accommodation hole 162 may be decreased. Thus, since the stator 100 is fixed to a constant position at the rear wall 21 of the tub 20 at all times, the concentricity error between the stator 100 and a rotor 200 is prevented, and the durability of the motor 40 is enhanced.

Hereinafter, a structure of preventing a phenomenon in which water is penetrated into the coils 130 in a state when the stator 100 is mounted at the rear wall 21 of the tub 20 will be described.

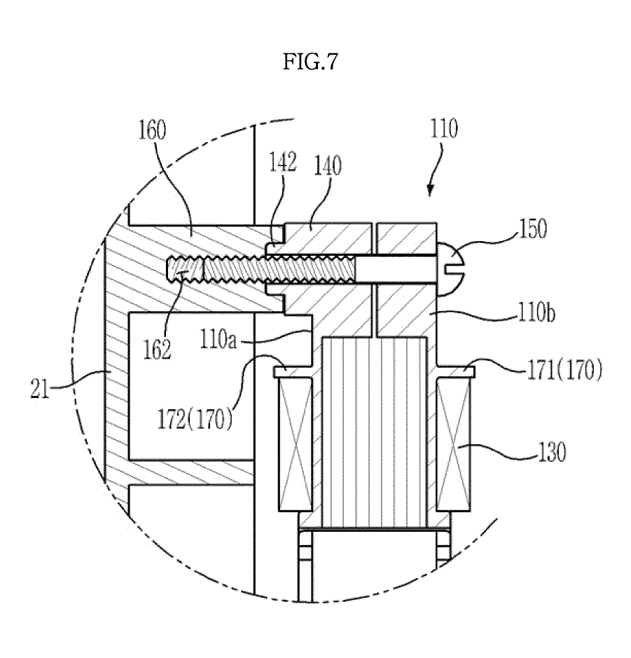

FIG. 7 is an enlarged view of ‘A’ portion of FIG. 1.

As illustrated on FIG. 1, FIG. 2, FIG. 4, and FIG. 7, the stator 100 includes at least one water penetrating prevention member 170 protruded from the stator body 110 to prevent water from being penetrated to the coil 130.

The water penetrating prevention member 170 includes a first water penetrating prevention rib 171 protruded toward the rear wall 21 of the tub 20 from the one side surface 110a of the stator body 110 facing the rear wall 21 of the tub 20 in a state when the stator 100 is fixed to the rear wall 21 of the tub 20, and a second water penetrating prevention rib 172 protruded toward an opposite direction of the first water penetrating prevention rib 171 from the other end surface 110b that is opposite to the one side surface 110a of the stator body 110.

The first water penetrating prevention rib 171 and the second water penetrating prevention rib 172 are each disposed in the circumferential direction of the stator 100, and are provided at an inner side in a radial direction of the stator 100 when compared to the fixing ribs 140.

The length in which the first water penetrating prevention rib 171 is protruded is needed to be shorter than the length in which the fixing rib 140 is protruded. If the length in which the first water penetrating prevention member 171 is protruded is longer than the length in which the fixing rib 140 is protruded, in the process of mounting the stator 100, the first water penetration prevention rib 171 may make contact with the rear wall 21 of the tub 20 before the fixing rib 140 makes contact with the rear wall 21, and thus the fixing rib 140 may not make contact with the support rib 160.

In addition, the first water penetrating prevention rib 171 and the second water penetrating prevention rib 172 may be integrally formed with the insulators 102a and 102b in the process of injection-molding the insulator 102a and 102b.

In a washing process, the water that is reached at an upper portion of the stator 100 by falling or being scattered from an upper portion of the tub 20 flows down toward a lower portion of the stator 100 along the surface of the first water penetrating prevention rib 171 or the second water penetrating prevention rib 172, and thus the penetration of the water into the coil 130 is prevented in advance.

FIG. 8 is an exploded perspective view illustrating an exploded structure of the stator.

As illustrated on FIG. 2, FIG. 4, and FIG. 8, the stator 100 includes the stator core 101 including a core body 101 a having an inner circumferential surface and an outer circumferential surface, and a plurality of core teeth 101b protruded in a radial structure toward a direction facing a center of the core body 101 a from the inner circumferential surface of the core body 101a, and the upper and the lower insulators 102a and 102b covering an outer side of the stator core 101. The stator core 101 may be formed in a method of stacking press-processed metal sheets.

The upper insulator 102a and the lower insulators 102b includes a plurality of penetration holes 144a and a plurality of penetrating holes 144b, respectively, the plurality of penetration holes 144a and the plurality of penetrating holes 144b forming the fixing holes 144 when the upper and the lower insulators 102a and 102b are coupled to each other, and the plurality of fixing ribs 140 and the plurality of fixing pins 142 are formed at one of the upper insulator 102a and the lower insulator 102b.

In addition, the upper and the lower insulators 102a and 102b are formed of the material having electrical insulation characteristic, and a connector housing 180 into which a connector 310, which is configured to supply power to the coil 130 wound at the upper and the lower insulators 102a and 102b for current to flow, is inserted at one of the upper and the lower insulators 102a and 102b. The connector housing 180 is integrally injection-molded with one of the upper and the lower insulators 102a and 102b in the process of injection-molding the upper and the lower insulators 102a and 102b.

Connection terminals 190 having metallic material that electrically connect the coil 130 to the connector 310 are inserted into the connector housing 180, and the connection terminals 190 may be inserted into the connector housing 180 in the process of injection-molding the upper and the lower insulators 102a and 102b.

As the above, by having the connector housing 180 integrally injection-molded with one of the upper and the lower insulators 102a and 102b, the cost of separately manufacturing the connector housing 180 is decreased, and since the process of assembling the connector housing 180 to the stator 100 is omitted, the productivity is enhanced.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A washing machine, comprising:
a body;
a tub disposed inside the body;
a drum rotatably disposed inside the tub; and
a motor coupled to a rear surface of the tub to drive the drum,
wherein the motor comprises:
a stator comprising at least one fixing pin inserted into the rear surface of the tub and at least one fixing hole concentrically disposed with the at least one fixing pin; and
a rotor rotatably disposed at an inner side or at an outer side of the stator.

2. The washing machine of claim 1, wherein the stator comprises:
a stator body having a circular-shape; and
at least one fixing rib disposed in a circumferential direction of the stator body, and protruded from one side surface of the stator body toward the rear surface of the tub,
wherein the at least one fixing pin protrudes from the at least one fixing rib toward the rear surface of the tub.

3. The washing machine of claim 2, wherein the at least one fixing hole is formed by penetrating through a center of the at least one fixing pin, through a portion of the stator body at which the center of the at least one fixing pin is positioned, and through the at least one fixing rib.

4. The washing machine of claim 3, wherein the tub comprises:
at least one first accommodation hole in which the at least one fixing pin is insertedly accommodated; and
at least one second accommodation hole concentrically disposed with the at least one first accommodation hole, and configured to communicate with the at least one fixing hole in a state that the at least one fixing pin is insertedly accommodated in the at least one first accommodation hole.

5. The washing machine of claim 4, further comprising:
at least one fixing member configured to fix the stator to the rear surface of the tub,
wherein the at least one fixing member is fixedly accommodated in the at least one second accommodation hole after passing through the at least one fixing hole.

6. The washing machine of claim 5, wherein the tub comprises a support rib protruded from the rear surface of the tub toward a rear side, and configured to support the stator by making contact with the at least one fixing rib when the stator is in a fixed state,
wherein the at least one first accommodation hole and the at least one second accommodation hole are formed at the support rib.

7. The washing machine of claim 1, wherein the stator comprises:
a stator body having a circular-shape;
a plurality of stator teeth arranged in a circumferential direction of the stator body;
a coil wound around the plurality of stator teeth; and
at least one water penetration prevention member protruded from the stator body and configured to prevent water from penetrating into the coil.

8. The washing machine of claim 7, wherein the at least one water penetration prevention member comprises:
a first water penetration prevention rib protruded from one surface of the stator body that faces the rear surface of the tub toward the rear surface of the tub when the stator is fixed to the rear surface of the tub; and
a second water penetration prevention rib protruded from the other surface of the stator body opposite to the one surface of the stator body in an opposite direction to the first water penetration prevention rib when the stator is fixed to the rear surface of the tub.

9. The washing machine of claim 7, wherein the at least one water penetration prevention member is disposed in the circumferential direction of the stator body.

10. The washing machine of claim 1, wherein the stator comprises:
a stator body having a circular-shape;
a plurality of stator teeth arranged in a circumferential direction of the stator body;
a coil wound around the plurality of stator teeth; and
a connector housing integrally formed with the stator body and into which a connector configured to supply power to the coil is inserted.

11. A washing machine, comprising:
a body;
a tub disposed inside the body;
a drum rotatably disposed inside the tub; and
a motor coupled to a rear surface of the tub to drive the drum,
wherein the motor comprises:
a stator comprising a stator body having a circular-shape; a plurality of stator teeth arranged in a circumferential direction of the stator body; a coil wound around the plurality of stator teeth; and at least one water penetration prevention member protruded from the stator body and configured to prevent water from penetrating into the coil; and
a rotor rotatably disposed at an inner side of the stator.

12. The washing machine of claim 11, wherein the at least one water penetration prevention member comprises:
a first water penetration prevention rib protruded from one surface of the stator body that faces the rear surface of the tub toward the rear surface of the tub when the stator is fixed to the rear surface of the tub, and
a second water penetration prevention rib protruded from the other surface of the stator body opposite to the one surface of the stator body in an opposite direction of the first water penetration prevention rib when the stator is fixed to the rear surface of the tub.

13. The washing machine of claim 11, wherein the at least one water penetration prevention member is disposed in the circumferential direction of the stator body.

14. The washing machine of claim 12, further comprising:
at least one fixing rib protruded from one side surface of the stator body toward the rear surface of the tub,
wherein the fixing rib is disposed at an outer side of the first water penetration prevention rib in a radial direction of the stator body.

15. A washing machine, comprising:
a body;
a tub disposed inside the body;
a drum rotatably disposed inside the tub; and
a motor configured to drive the drum,
wherein the motor comprises:
a stator comprising a stator core; an insulator covering the stator core; a coil wound around the insulator; and a connector housing integrally formed with the insulator and into which a connector configured to supply power to the coil is inserted; and
a rotor rotatably disposed at an inner side or at an outer side of the stator.

16. The washing machine of claim 15, wherein:
the insulator comprises an upper insulator and a lower insulator that are configured to cover the stator core from an upper side and a lower side thereof, respectively, and
the connector housing is integrally formed with one of the upper insulator and the lower insulator.

17. The washing machine of claim 15, further comprising connection terminals formed of metal configured to electrically connect the coil to the connector,
wherein the connection terminals are inserted into the insulator.

18. The washing machine of claim 1, wherein:
the at least one fixing rib comprises a plurality of fixing ribs separated from each other and disposed in the circumferential direction of the stator body, and protruded from one side surface of the stator body toward the rear surface of the tub, and
the at least one fixing pin comprises a plurality of fixing pins and each fixing pin protrudes from each fixing rib toward the rear surface of the tub.
